(19) United States
(12) Patent Application Publication
(10) Pub. No.: US 2011/0075420 A1
(43) Pub. Date: Mar. 31, 2011

(54) LIGHT OUTPUT DEVICE AND METHOD

(75) Inventors: Ramon Pascal Van Gorkom, Eindhoven (NL); Arij Jonathan Rijke, Eindhoven (NL); Martin Jacobus Johan Jak, Eindhoven (NL)

(73) Assignee: KONINKLIJKE PHILIPS ELECTRONICS N.V., EINDHOVEN (NL)

(21) Appl. No.: 12/994,869

(22) PCT Filed: Jun. 5, 2009
(86) PCT No.: PCT/IB2009/052379

§ 371 Date: Nov. 29, 2010

(30) Foreign Application Priority Data
Jun. 10, 2008 (EP) 08157934.4

(51) Int. Cl. F21V 7/00; F21V 7/06

(52) U.S. Cl. 362/235

(57) ABSTRACT

The present invention relates to a light output device (10, 50, 70), comprising: a first light source (12a, 52a, 72a); a second light source (12b, 52b, 72b); and a partly transparent mirror (16, 56, 76). The device is characterized in that the partly transparent mirror, during operation, receives substantially all light emitted by the first and second light sources, and reflects part of the light emitted by the first light source and transmits part of the light emitted by the second light source, and vice versa, such that the light from the first light source is completely superimposed onto the light from the second light source following reflection/transmission at the partly transparent mirror. The present invention also relates to a light output method.

### FIELD OF THE INVENTION

The present invention relates to a light output device, comprising: a first light source; a second light source; and a partly transparent mirror. The present invention also relates to a light output method.

### BACKGROUND OF THE INVENTION

A light output device of the type mentioned by way of introduction is disclosed in the US-patent application US 2006/0274421 A1 (Okamitsu et al.). In particular, in relation to FIG. 1a in US 2006/0274421 A1, there is described a solid state light source comprising a pair of light emitting arrays. The light emitting arrays output light rays which pass directly to a target surface, whereas other rays produce a combined irradiance produced by an optical mixing element on which the other rays are incident. The optical mixing element may be a semi-reflective mirror which substantially splits the emission of the other rays into reflected rays and transmitted rays which are mixed such that they are superimposed on each other.

However, a problem with the solid state light source of FIG. 1a in US 2006/0274421 A1 is that the light rays which pass directly to the target surface contribute to an uneven mixing at the target surface.

### SUMMARY OF THE INVENTION

It is an object of the present invention to at least partly overcome this problem, and to provide a light output device with improved mixing.

This and other objects that will be apparent from the following description are achieved by a light output device and method according to the appended independent claims.

According to an aspect of the present invention, there is provided a light output device, comprising: a first light source; a second light source; and a partly transparent mirror, wherein the partly transparent mirror, during operation of the device, receives substantially all light emitted by the first and second light sources, and reflects part of the light emitted by the first light source and transmits part of the light emitted by the second light source, and vice versa, such that the light from the first light source is completely superimposed onto the light from the second light source following reflection/transmission at the partly transparent mirror.

Since all light emitted by the first and second light sources hits the partly transparent mirror, perfect mixing may be achieved. Furthermore, no diffuser(s) need(s) to be added, which means that highly collimated beams can be provided.

In advantageous embodiments of the present invention, the partly transparent mirror is a semi-transparent or semi-reflective mirror (that is, about half of the incoming light is reflected, while the other half is transmitted), the first and second light sources are arranged symmetrically one on each side of the partly transparent mirror, and/or the first and second light sources have substantially identical radiation patterns.

Further, the first light source is preferably adapted to emit light having a first wavelength spectrum, whereas the second light source is adapted to emit light having a second wavelength spectrum different from the first wavelength spectrum. In this way, two different colors, or colored and white light, may advantageously be mixed.

Preferably, each of the first and second light sources comprises at least one light emitting diode (LEDs). The LEDs of each light source may be of the same or different colors. Benefits of LEDs include high efficiency, long useful life, etc. However, other light sources such as lasers, fluorescent lamps, TL-tubes, etc. could instead be used in some embodiments.

Also preferably, the present device further comprises collimating means adapted to at least partly collimate the light of the first and second light sources such that during operation substantially all the at least partly collimated light of the first and second light sources is incident on the partly transparent mirror.

In one embodiment, during operation of the device, the at least partly collimated light of the first and second light sources is incident on the partly transparent mirror such that a first and second mixed beam is produced, wherein the light output device further comprises a plane mirror for re-directing one of the first and second mixed beams in the direction of the other mixed beam. In this embodiment, the collimating may comprise two half compound parabolic concentrators (CPCs), one for each light source, though other collimating means could be used, like normal CPCs or Cassegrain collimators. By optimizing the angle of collimation and the angle between the collimating means and the partly transparent mirror, the size of the light output device may be minimized. In this embodiment, the device preferably comprises at least one lens adapted to focus the superimposed light, in order to beneficially regain lost etendue. Instead of a lens, a specially adapted mirror could be used to focus the light.

In another embodiment, the collimating means comprises two parabolic mirrors, wherein the partly transparent mirror is arranged between the two parabolic mirrors, and wherein the first light source is arranged on the optical axis of one of the parabolic mirrors between the one parabolic mirror and the focal point of the one parabolic mirror, and the second light source is arranged on the optical axis of the other parabolic mirror between the other parabolic mirror and the focal point of the other parabolic mirror. In this embodiment, no lens is needed, but the device preferably comprises a secondary collimating means adapted to collimate the superimposed light. The post-collimation after mixing has the advantage that the device remains small. Instead of the parabolic mirrors, other shapes could be used, like ellipsoids, facetted mirrors, etc.

In yet another embodiment, the device further comprises additional light sources, the light sources of the device being arranged in two rows, one row on each side of the partly transparent mirror, providing a linear light output device.

According to an aspect of the present invention, there is provided a light output method, comprising: by means of a partly transparent mirror, receiving substantially all light emitted by a first light source and a second light source; and by means of the partly transparent mirror, reflecting part of the light emitted by the first light source and transmitting part of the light emitted by the second light source, and vice versa, such that the light from the first light source is completely superimposed onto the light from the second light source following reflection/transmission at the partly transparent mirror. Advantages and features of the this aspect of the present invention are analogous to those of the above described aspect of the invention.

### BRIEF DESCRIPTION OF THE DRAWINGS

These and other aspects of the present invention will now be described in more detail, with reference to the appended drawings showing currently preferred embodiments of the invention.

FIG. 1 is a schematic cross-sectional side view of a light output device according to an embodiment of the present invention.

FIG. 2 is a perspective view of a half CPC of the device in FIG. 1.

FIG. 3 is a schematic cross-sectional side view of a light output device according to another embodiment of the present invention.

FIG. 4 is a schematic bottom view of the device in FIG. 3.

FIG. 5 is a perspective view of an optional collimator for the device in FIGS. 3 and 4.

FIG. 6 is a schematic perspective view of a light output device according to yet another embodiment of the present invention.

FIG. 7a is a schematic bottom view of the device in FIG. 6.

FIG. 7b is a schematic bottom view of a variant of the device in FIGS. 6 and 7a.

FIG. 8 is a flow chart of a light output method according to the present invention.

### DETAILED DESCRIPTION

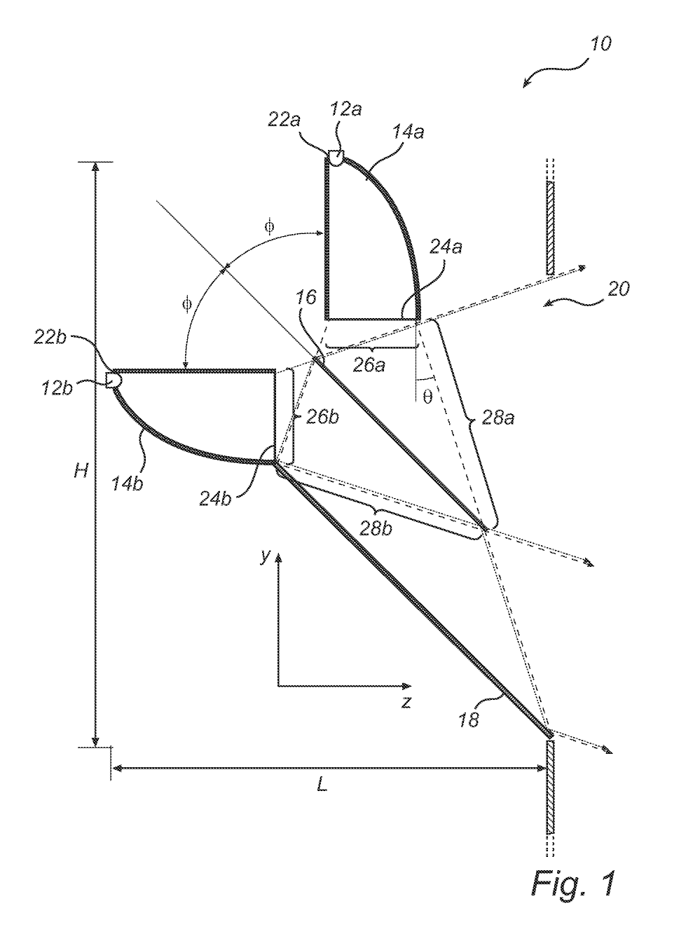

FIG. 1 is a schematic cross-sectional side view of a light output device 10 according to an embodiment of the present invention.

The light output device 10 comprises two light sources, specifically two LEDs 12a, 12b, as well as two half-CPCs 14a, 14b, a semi transparent mirror 16, a plane mirror 18, and an exit aperture 20.

The LEDs 12a, 12b are of different colors (including white). The LED 12a may for instance be adapted to emit red light, and the other LED 12b may be adapted to emit green light, for mixing red and green light. The LEDs 12a, 12b may for instance be top-emitting LEDs. The two LEDs 12a, 12b have the same radiation patterns.

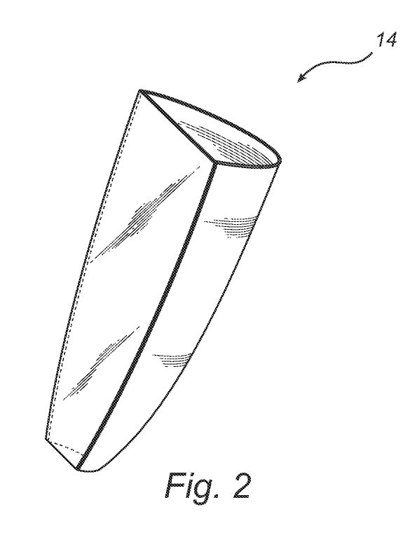

A half-CPC is a collimator which consists of a CPC cut in half by a mirror. The function of the mirror may be achieved by means of (total) internal reflection. In FIG. 2, a perspective view a half-CPC is illustrated. The plane portion is the mirror, whereas the curved portion is half a CPC. A half-CPC does not have the same angular distribution as a CPC, but the maximum collimation angle is the same. In the present device, a half-CPC is preferably used instead of a CPC, because this allows the collimators to be placed closer together, which in turn reduces the size of the device 10. The half-CPCs 14a, 14b of the device 10 are of equal size and shape.

The semi transparent or semi reflective mirror 16 generally transmits one half of incoming light and reflects the other half of incoming light, to produce mixed light comprising substantially equal amounts of light from each of the LED 12a, 12b. The semi transparent mirror 16 may beneficially be made up of a substrate with a 25% reflector on each side.

In the device 10, the LEDs 12a, 12b are located at the entrances 22a, 22b of the half CPCs 14a, 14b, as illustrated in FIG. 1, and the two half-CPCs 14a, 14b are arranged mirrorwise towards the semi transparent mirror 16. The half-CPCs 14a, 14b in FIG. 1 are placed so that the most diverging outgoing rays of one of the half-CPCs just miss the exit surface 24a, 24b of the other half-CPC, as seen from the radiation patterns 26a, 26b. Further, the exits surfaces 24a, 24b of the half-CPCs 14a, 14b are arranged at about 90 degrees in relation to each other, while is semi transparent mirror 16 is arranged at about 45 degrees in relation to the exits surfaces, as seen from the perspective of FIG. 1. Further, with respect to the radiation patterns 26a (dashed lines), 26b (dotted lines) of the light sources (following collimation by the half-CPCs 14a, 14b) and the placement of the light sources (and the half-CPCs) and the semi transparent mirror 16, the semi transparent mirror 16 is sized such all light emitted by the light sources (as shaped by the half-CPCs 14a, 14b) hits the semi transparent mirror 16. Further, the plane mirror 18 is arranged parallel to the semi transparent mirror 16, one end of the plane mirror 18 adjoining one end of one of the exit surfaces 24a, 24b, as illustrated in FIG. 1. The plane mirror 18 is sized such that the light from 14a transmitted through the mirror 16 and the light from 14b reflected by the mirror 16 hits the plane mirror 18, at least once.

During operation of the light output device 10, light emitted by the LEDs 12a, 12b is at least partly collimated by the half-CPCs 14a, 14b, resulting in radiation patterns 26a, 26b. All light emitted by the LEDs 12a, 12b hits the semi transparent mirror 16. About half of the light emitted by the LED 12a is reflected by the semi transparent mirror 16, while the other half is transmitted through the semi transparent mirror 16. Likewise, about half of the light emitted by the LED 12b is reflected by the semi transparent mirror 16, while the other half is transmitted through the semi transparent mirror 16. Due to the above described arrangement of the device 10, the light emitted by the LED 12a and reflected by the semi transparent mirror 16 is perfectly superimposed on the light emitted by the LED 12b and transmitted through the semi transparent mirror 16, forming mixed beam 28a. Likewise, the light emitted by the LED 12a and transmitted through the semi transparent mirror is perfectly superimposed onto the light emitted by the LED 12b and reflected by the semi transparent mirror, forming mixed beam 28b. The mixed beam 28a is immediately directed towards the exit aperture 20 of the device 10. The mixed beam 28b on the other hand is first incident on the plane mirror 18, which plane mirror 18 re-directs the mixed beam in the same direction as the mixed beam 28a towards the exit aperture 20, as illustrated in FIG. 1. Due to the above described arrangement of the device 10, the beam 28b exits the aperture 20 next to the beam 28a. The exit aperture 20 is preferably sized and located such that substantially all light of the mixed beams 28a, 28b may be outputted from the device 10.

Indeed, in the device 10, the light sources (LEDs 12a, 12b) of different colors are perfectly overlapped by making virtual light sources with the help of mirror images. In other words, each light source appears to be placed at two different positions. Simulations show that the present device 10 perfectly mixes light.

For the light output device 10, besides the size of the collimator (i.e. the half-CPCs 14a, 14b), the angle of collimation (θ), and the angle (φ) between the half-CPCs 14a, 14b and the semi transparent mirror 16 determine the size of the various elements in the device 10, and therefore the size of the device 10. The length L×height H product can be optimized. The length L and height H are indicated FIG. 1. For θ=24° and φ=45° this product is minimal. This product is proportional to the square of the entrance radius of the CPCs 14a, 14b. For an entrance radius of 1.5 mm, the device 10 will have a length and height of 29 mm and 28 mm respectively. The depth (x-direction in FIG. 1) of the device 10 is 26 mm.

Further, the rays can be collimated in the depth direction. In the present embodiment, no collimator is applied in the depth direction, though such a collimator could be added. If no collimator is placed to collimate the rays in the depth direction, then device volume is minimal for θ32 24°. Collimating the light in the depth direction will reduce the size of the exit aperture, as well as reduce the increase of etendue.

Also in the present embodiment, etendue is minimal for φ=45° and for θ as small as possible. For θ=24° and φ=45°, the etendue at the exit aperture 20 is about thirty times the etendue at the entrance the half-CPCs. The etendue is larger because the rays keep diverging as they go through the device 10. Therefore, preferably a lens (not shown) is placed at the exit aperture 20 or at each exit surface 24a, 24b of the other half-CPCs 14a, 14b. This lens narrows the divergence of the beam(s), and hence reduces the etendue.

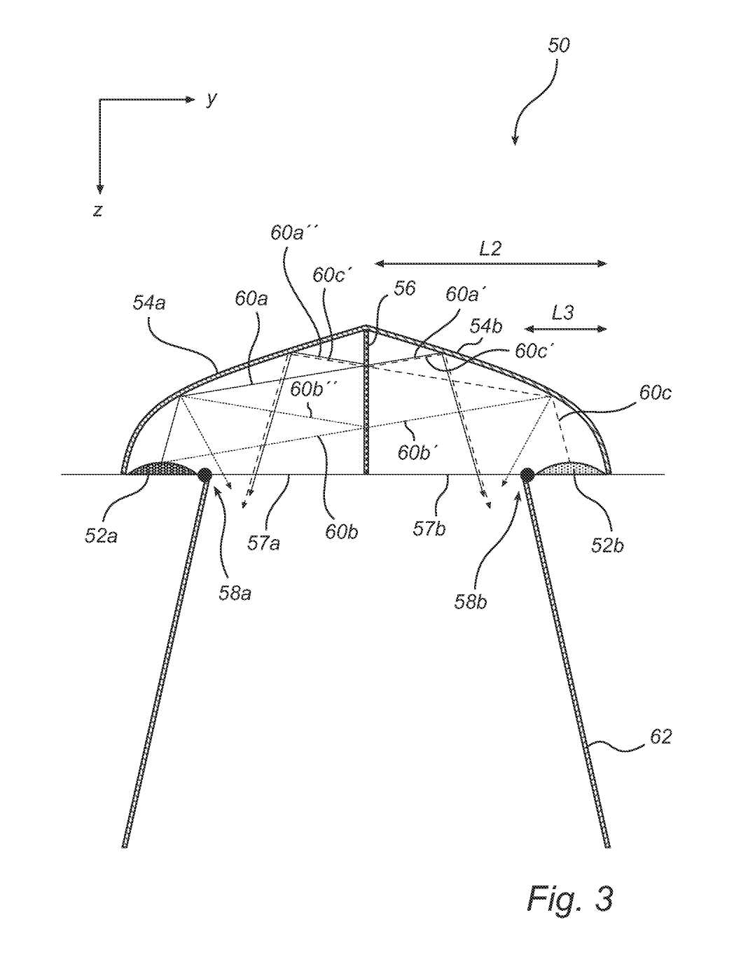

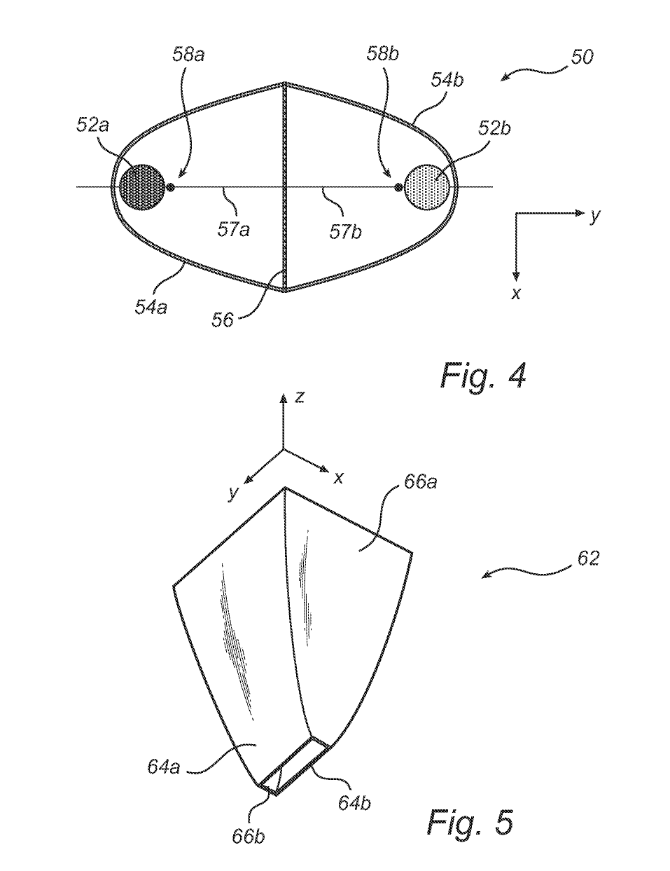

FIG. 3 is a schematic cross-sectional side view of a light output device 50 according to another embodiment of the present invention, and FIG. 4 is a schematic bottom view of the device of FIG. 3

The light output device 50 comprises two light sources, specifically two LEDs 52a, 52b, as well as two parabolic imaging collimators or parabolic mirrors 54a, 54b, and a semi transparent mirror 56.

The LEDs 52a, 52b are of different colors (including white), and may for instance be top-emitting LEDs. The two LEDs 52a, 52b have the same radiation patterns. The parabolic mirrors 54a, 54b are of equal size and shape. The semi transparent or semi reflective mirror 56 is similar to the semi transparent mirror 16 described above.

The semi transparent mirror 56 is placed between the two opposed, adjoining parabolic mirrors 54a, 54b, as illustrated in FIGS. 3 and 4. The semi transparent mirror 56 completely “covers” the passage between the two parabolic mirrors 54a, 54b. The LED 52a is placed on the optical axis 57a of the parabolic mirror 54a, between the parabolic mirror 54a and its focal point 58a. The LED 52a is generally oriented such that some emitted light is directed towards the parabolic mirror 54a, while the rest of the emitted light is directed directly towards the semi transparent mirror 56. Likewise, and symmetrically, LED 52b is placed on the optical axis 57b of the parabolic mirror 54b, between the parabolic mirror 54b and its focal point 58b, and is generally oriented such that some emitted light is directed towards the parabolic mirror 54b, while the rest of the emitted light is directed directly towards the semi transparent mirror 56. Light from the LEDs directed directly towards the semi transparent mirror will also be focused in between the two LEDs.

During operation of the device 50, an exemplary light ray 60a (solid line) from the LED 52a that hits the parabolic mirror 54a before reaching the semi transparent mirror 56 is re-directed by the parabolic mirror towards the other parabolic mirror 54b. At the semi transparent mirror 56, the ray 60a is split into ray 60a′ transmitted through the semi transparent mirror 56 and ray 60a″ reflected by the semi transparent mirror 56. The transmitted ray 60a′ is then re-directed or projected by the parabolic mirror 54b towards the optical axis 57b. Likewise, the reflected ray 60a″ is re-directed or projected by the parabolic mirror 54a towards the optical axis 57a. Another exemplary ray 60b (dotted line) from the LED 52a that hits the semi transparent mirror 56 directly is split into ray 60b′ transmitted through the semi transparent mirror 56 and ray 60b″ reflected by the semi transparent mirror 56, which rays 60b′, 60b″ also are re-directed and projected towards the optical axes 57b, 57a, respectively. With suitably chosen dimensions, all light is projected between the light sources.

Analogous to this, the light which is emitted from the other light source 52b is also directed between both light sources. Since the two parabolic mirrors 54a, 54b, as well as the two LEDs 52a, 52b, are on each others mirror images as imaged by the semi transparent mirror 56, the rays that hit the semi transparent mirror 56 on the one side are overlayed on the rays which hit the semi transparent mirror 56 from the other side. Therefore, the rays reflected by the semi transparent mirror 56 are also projected between the two light sources. For instance, an exemplary light ray 60c (dashed line) emitted from the LED 52b is split by the semi transparent mirror 56 into transmitted ray 60c′ and reflected ray 60c″, the ray 60c′ being superimposed onto the ray 60a″ and the ray 60c″ being superimposed on the ray 60a′.

Indeed, in the device 50, the light sources (LEDs 52a, 52b) of different colors are perfectly overlapped by making virtual light sources with the help of mirror images. In other words, each light source appears to be placed at two different positions, like in the device 10. However, in the device 50, imaging optics (e.g. the parabolic mirrors 54a, 54b) are used to keep the device small.

Further, in the device 50, the place of the LEDs 52a, 52b relative to the position of the focus 58a, 58b of the parabolic mirrors 54a, 54b and the length L2 of the parabolic mirrors 54a, 54b determines where the rays leave the device 50. For optimal output, the dimensions of the device 50 should be chosen such that all light is projected between the two LEDs 52a, 52b, on a area as small as possible. Also the total size of the device 50 should be minimal. When each LED lies between the parabolic mirror and its focal point and the total length L2 of the parabolic mirror 54a, 54b is three times the focal length L3, the requirements are met. L2 and L3 are indicated in FIGS. 3 and 4. Theoretically, a parabolic mirror length L2 of 3/2 times the focal length L3 is also sufficient, however in practice it is not.

In the light output device 50 described so far, at the exit surface of the parabolic mirrors 54a, 54b, the superimposed light is somewhat collimated in the y-direction, and not collimated in the x-direction. To collimate the light in two directions, the device may further comprise a secondary collimator (not shown in FIG. 4 for the sake of clarity) arranged at the exit surface of the parabolic mirrors 54a, 54b. The shape of an exemplary secondary collimator 62 is shown in FIG. 5. The secondary collimator 62 comprises opposite parabolic mirrors 64a, 64b linked by opposite plane mirrors 66a, 66b. During operation, light in the x-direction is collimated using the parabolic mirrors 64a, 64b, whereas light in the y-direction is collimated using the plane mirrors 66a, 66b. The choice of the different shapes for the different directions is because the light coming out of the parabolic mirrors 54a, 54b is already partially collimated in one direction and because the collimator input irradiance distribution has a elliptical shape.

Instead of the secondary collimator 62, other optical means could be used. For instance, an asymmetric decollimator which shrinks the size of the spot in the y-direction could be used, though the beam divergence will increase. This will make the angular distribution more symmetric and the spot more round. After the decollimation, a symmetric collimator can be placed to obtain the desired beam divergence.

An exemplary device 50 is designed to have a circular input area of 2.55 mm in diameter for each light source 52a, 52b. For these input areas, the device 50 has a length of 40 mm, and a output area of 22×20 mm. For this size, the outgoing beam has 80% of the flux contained within outgoing angles of ±20° and ±10°. The etendue of the beam including 80% of the light is two times the etendue in when both LEDs are lit. This etendue loss of a factor 2 is caused by the secondary collimator, but is not fundamental.

Simulations show that the device 50 provides perfect color mixing. Compared to the device 10 of FIGS. 1-2, the device 50 features a great reduction of etendue increase, and there is also a volume reduction. For both devices the mixing quality is the same.

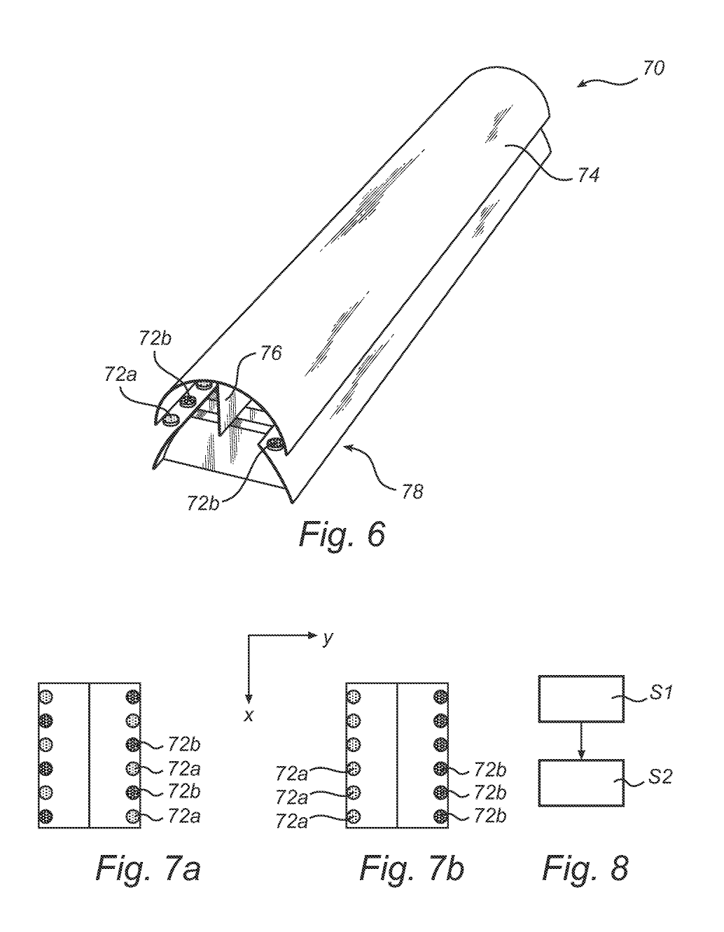

FIG. 6 is a schematic perspective view of a light output device 70 according to yet another embodiment of the present invention. The device 70 comprises LEDs, a parabolic mirror structure 74, a semi transparent mirror 76, and secondary collimating means 78. The cross-section of the device 70 is similar to that of the light output device 50, but the device 70 comprises additional LEDs. The LEDs are arranged in two rows in the x-direction. The device 70 is like several device 50 placed after each other in the x-direction, but with a common parabolic mirror structure 74 and semi transparent mirror 76. The LEDs comprise LEDs 72a adapted to emit light having a first color, and LEDs 72b adapted to emit light having a second, different color (or white light). Preferably, the two types of LEDs are placed in an alternating arrangement, as illustrated in FIG. 7a. Alternatively, all LEDs 72a of the first color are arranged in one of the rows, and all LEDs 72b of the second color or white are arranged in the other row, as illustrated in FIG. 7b. In the device 70, the two rows of LEDs could be replaced by two different TL tubes.

FIG. 8 is a flow chart of a light output method according to the present invention, as performed for instance in the above described devices, the method comprising the steps of: by means of a partly transparent mirror, receiving (step S1) substantially all light emitted by a first light source and a second light source; and by means of the partly transparent mirror, reflecting part of the light emitted by the first light source and transmitting part of the light emitted by the second light source, and vice versa (step S2), such that the light from the first light source is completely superimposed onto the light from the second light source following reflection/transmission at the partly transparent mirror.

Applications of the present device and method include, but are not limited to, spot lights for lighting or illumination, as the present device fulfills demands for spot lights, including that producing a very small beam, having a small volume, and having a small exit diameter. Other applications include down lights, stage lights, microscope illumination, etc.

The person skilled in the art realizes that the present invention by no means is limited to the preferred embodiments described above. On the contrary, many modifications and variations are possible within the scope of the appended claims.

For example, more than one LED could be used in each light source. For instance, for mixing cold and warm white together, a warm white LED and a cold white LED can be placed at each entrance or input of the collimating means, e.g. one above the other. The top position at the one entrance should be the warm white, while the top position at the other entrance should be the cold white, in such a way that a mirror image of a cold white will always appear on top of a warm white LED, and visa versa.

Also, instead of only two colors, the present devices could include more colors, e.g. by placing two semi transparent mirrors in a cross configuration, and adjusting the incoming angles of the light such that the light is guaranteed to hit both semi transparent mirrors. Another way to provide more than two colors is by placing two devices in series.

1. A light output device, comprising:
a first light source;
a second light source; and
a partly transparent mirror, and
collimating means for at least partly collimating the light of the first and second light sources, such that during operation substantially all the at least partly collimated light of the first and second light sources is incident on the partly transparent mirror; the partly transparent mirror, during operation, receiving substantially all the at least partly collimated light emitted by the first and second light sources, and reflecting part of the light emitted by the first light source and transmitting part of the light emitted by the second light source, and vice versa, such that the light from the first light source is completely superimposed onto the light from the second light source following reflection/transmission at the partly transparent mirror, wherein said collimating means comprise mirror-wise arranged portions corresponding to said first light source and said second light source, respectively, said first light source and said second light source being arranged on opposite outer ends of said collimating means.

2. A light output device according to claim 1, wherein the partly transparent mirror is a semi-transparent mirror.

3. A light output device according to claim 1, wherein the first and second light sources are arranged symmetrically one on each side of the partly transparent mirror.

4. A light output device according to claim 1, wherein the first and second light sources have substantially identical radiation patterns.

5. A light output device according to claim 1, wherein the first light source is adapted to emit light having a first wavelength spectrum, and wherein the second light source is adapted to emit light having a second wavelength spectrum different from the first wavelength spectrum.

6. A light output device according to claim 1, wherein each of the first and second light sources comprises at least one light emitting diode.

7. (canceled)

8. A light output device according to claim 1, wherein during operation the at least partly collimated light of the first and second light sources is incident on the partly transparent mirror such that a first and second mixed beam is produced, the light output device further comprising a plane mirror for re-directing one of the first and second mixed beams in the direction of the other mixed beam.

9. A light output device according to claim 8, further comprising at least one lens adapted to focus the superimposed light.

10. A light output device according to claim 1, wherein the collimating means comprises two parabolic mirrors, the partly transparent mirror is arranged between the two parabolic mirrors, and the first light source is arranged on the optical axis of one of the parabolic mirrors between the one parabolic mirror and the focal point of the one parabolic mirror, and the second light source is arranged on the optical axis of the other parabolic mirror between the other parabolic mirror and the focal point of the other parabolic mirror.

11. A light output device according to claim 10, further comprising a secondary collimating means adapted to collimate the superimposed light.

12. A light output device according to claim 10, further comprising additional light sources, the light sources of the device being arranged in two rows, one row on each side of the partly transparent mirror.

13. (canceled)

14. A light output method, comprising:
at least partly collimating light emitted by a first light source and a second light source, each of said first and second light source being arranged on respective outer ends of a collimating means receiving substantially all light emitted by a first light source and a second light source by a partly transparent mirror; and
reflecting part of the light emitted by the first light source and transmitting part of the light emitted by the second light source, and vice versa, such that the light from the first light source is completely superimposed onto the light from the second light source following reflection/transmission at the partly transparent mirror.
